(19) United States
(12) Patent Application Publication
(10) Pub. No.: US 2020/0354144 A1
(43) Pub. Date: Nov. 12, 2020

(54) Combo Dustpan andTrash Can/Bucket

(71) Applicant: Deirdre Lynn Thompson, Sandy Springs, GA (US)

(72) Inventor: Deirdre Lynn Thompson, Sandy Springs, GA (US)

(21) Appl. No.: 16/872,025

(22) Filed: May 11, 2020

Related U.S. Application Data
(60) Provisional application No. 62/845,333, filed on May 9, 2019.

(51) Int. Cl. B65F 1/14

(52) U.S. Cl. CPC B65F 1/14

(57) ABSTRACT

Combination Dustpan and Trash Can/Bucket, functions as a trash can or bucket that allows the user to sweep directly into its own container. It has multiple functions for any user, and it also provides an ease of use for all age groups, including those with physical limitations. The materials of this product will be (but not limited to), in the form of a hard plastic and/or stainless steel.

I, Deirdre Lynn Thompson have invented a new design for a Combination Dustpan and Trash Can/Bucket as set forth in the following specification:

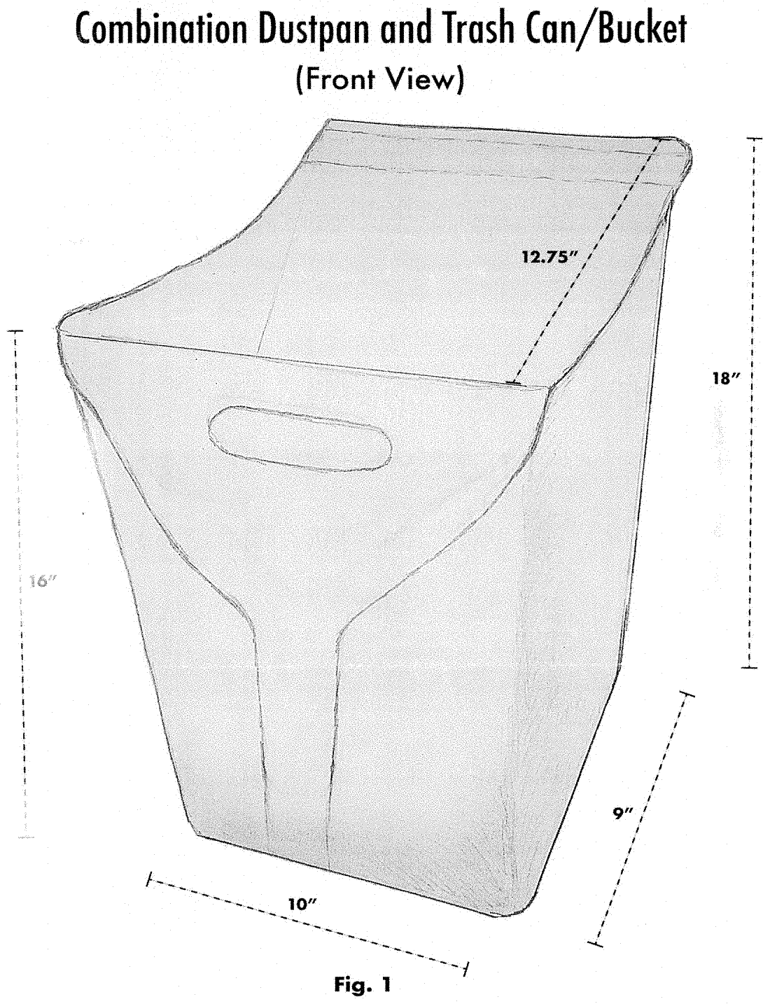

FIG. 1 is a front view of the Combination Dustpan and Trash Can/Bucket showing my new design with its overall dimensions;

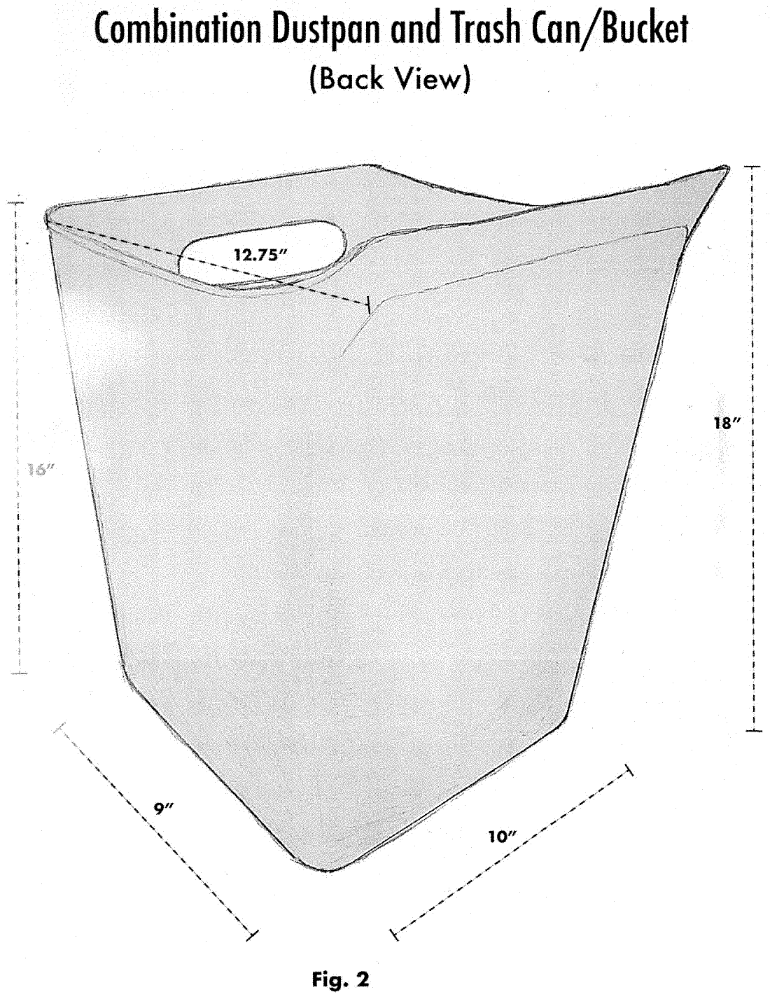

FIG. 2 is a back view of the Combination Dustpan and Trash Can/Bucket view thereof

1. Combination Dustpan and Trash Can/Buckets rectangular structure consists of a horizontal handle for comfortable maneuvering; and a curved lip shovel-like apparatus, which is uniquely engineered that when laid flat on the floor allows the user to sweep directly into the trash can/basket while discarded contents stay in place.
